(19) United States
(12) Patent Application Publication
(10) Pub. No.: US 2024/0243299 A1
(43) Pub. Date: Jul. 18, 2024

(54) Electrode and Electrochemical Storage Cell

(71) Applicant: Bayerische Motoren Werke Aktiengesellschaft, Muenchen (DE)

(72) Inventors: Wonsup HAN, Suwon-Si, Kwonsun-Ku (KR); Hyunchul ROH, Muenchen (DE); Nina ZENSEN, Pfaffenhofen an der Ilm (DE)

(21) Appl. No.: 18/558,758

(22) PCT Filed: Apr. 26, 2022
(86) PCT No.: PCT/EP2022/061021

§ 371 Date: Nov. 3, 2023

(30) Foreign Application Priority Data
May 6, 2021 (DE) 10 2021 111 821.2

(51) Int. Cl. H01M 4/70; H01M 4/02; H01M 10/0525; H01M 10/0587; H01M 50/107

(52) U.S. Cl. CPC H01M 4/70; H01M 10/0587; H01M 50/107; H01M 2004/027; H01M 10/0525

(57) ABSTRACT

An electrode for an electrochemical storage cell is provided. The electrode includes an outgoing conductor foil and an electrode coating applied to the conductor foil. The conductor foil has a first portion and a second portion, adjoining the first portion in the longitudinal direction of the conductor foil, and has a side edge, which extends from a first end of the conductor foil over the first portion and the second portion to a second end of the conductor foil, opposite from the first end along the longitudinal direction. The conductor foil also has a number of outgoing conductor lugs, extending from the side edge and intended for electrically contacting the electrode, wherein the outgoing conductor lugs are arranged in the first portion of the outgoing conductor foil and the first portion extends from the first end of the outgoing conductor foil to at most the middle of the side edge.

### BACKGROUND AND SUMMARY

The invention relates to an electrode for an electrochemical storage cell and also to an electrochemical storage cell.

An electrochemical storage cell is an electrochemically based energy store which in particular is rechargeable and is adapted to storing electrical energy and providing it to consumer units, more particularly, consumer units in a vehicle.

Factors critical to the performance of an electrochemical storage cell are the attainable energy density, the lifetime, and the charging and discharging rates available, which are particularly important in vehicle applications and should be as high as possible. The available charging and discharging rates are limited, however, by a variety of effects, including the anticipated temperature profile during charging and discharging, and by aging effects.

A particular factor in the increase in temperature is the electrical resistance of the electrochemical storage cell. The electrical resistance is dependent in turn on the transport length of electrons within electrodes of the electrochemical energy store, and also on the geometry of electrode collector lugs which are used for electrical contacting. In order to reduce the overall level of heat given off by the electrochemical storage cell, it is known practice to provide multiple collector lugs over the length of the electrode and in this way to reduce the transport length of the electrons and also the local heating per collector lug.

This, however, gives rise to the need to accommodate the multiplicity of collector lugs within a housing of the electrochemical energy store, with the collector lugs typically being disposed on a top and/or bottom side of what is called a “jelly roll”, the “jelly roll” being a coil of rolled-up electrodes with separators disposed between each of the electrodes.

However, the collector lugs may have adverse consequences for other processes in the production of the electrochemical storage cell, and/or on the operation of said cell. In particular, they may hinder the filling of the electrochemical storage cell with electrolyte and/or may hinder degassing of the electrochemical storage cell, with the possible consequences of more complicated processes and of a reduced lifetime.

It is an object of the invention to provide a means of enabling a reliable electrochemical storage cell featuring high performance.

The object of the invention is provided by an electrode for an electrochemical storage cell, comprising a collector foil and an electrode coating applied to the collector foil. The collector foil has a first portion and a second portion, bordering the first portion in the longitudinal direction of the collector foil, and has a side edge which extends from a first end of the collector foil to a second end, opposite along the longitudinal direction, of the collector foil, over the first portion and the second portion. Further, the collector foil has multiple collector lugs starting from the side edge, for electrically contacting the electrode, with the collector lugs being disposed in the first portion of the collector foil and with the first portion extending from the first end of the collector foil to at most the middle of the side edge.

The electrode of the invention makes it possible, through the use of multiple collector lugs, to reduce the electrical resistance of the electrode and in this way to limit the evolution of temperature in the operation of the electrode.

In the invention, moreover, the collector lugs are disposed only in a subregion of the electrode, more specifically in the first portion. This creates a preferential direction of the electrode, allowing the later positioning of the collector lugs in an electrochemical storage cell to be selected.

In particular, the electrode may be rolled up starting from the second end toward the first end, so that the collector lugs in the wound state are located radially further to the outside. In this way, with no change in the number and/or geometry of the collector lugs, it is possible to ensure that, even in an installed position of the electrode, the lugs can be disposed with at least partly no overlap, preferably with completely no overlap. In this way, even in the installed position of the electrode, openings remain between the collector lugs, and may be utilized for electrolyte filling and/or for degassing of the electrochemical storage cell.

To ensure sufficient stability and also sufficient electrical conductivity, the collector foil is more preferably a copper or aluminum foil. If the electrode is an anode, the collector foil more preferably is a copper foil. If the electrode is a cathode, the collector foil more preferably is an aluminum foil.

The collector lugs are preferably an integral constituent of the collector foil. In this way, no additional operating steps have to be carried out for securing the collector lugs, and the collector lugs are connected stably to the rest of the constituents of the electrode, thereby extending the lifetime of the electrode.

The collector lugs may be produced via laser cutting or mechanical cutting of a precursor of the collector foil to form the side edge and the collector lugs.

The collector lugs may be produced before or after the application of the electrode coating.

In one embodiment, ten or fewer collector lugs are present, preferably six to eight collector lugs. A greater number of collector lugs raises the footprint of the collector lugs. With a smaller number of collector lugs, the intended reduction in electrical resistance becomes increasingly difficult to achieve.

In principle, for a given longitudinal extent of the first region along the longitudinal direction of the collector foil, the overlap of collector lugs in the installed position of the electrode, even with a relatively high number of collector lugs, may be limited by reducing the width of the individual collector lugs along the longitudinal direction. This, however, has the consequence of an increasing mechanical weakening of the collector lugs, which may negatively impact the lifetime of the electrode.

In order to enable extremely uniform current flow within the electrode, the collector lugs may be disposed at a uniform distance from one another. Furthermore, a configuration of this kind allows symmetrical arrangements of the collector lugs to be produced in an installed position of the electrode.

The length of the collector lugs perpendicularly to the longitudinal direction of the collector foil is, in particular, shorter than the distance of the collector lugs from one another. In this way, the overlap of the collector lugs in the installed position of the electrode may be further reduced or excluded.

The electrode may be a cathode or an anode, the electrode preferably being an anode.

In the electrode coating, all active materials may be employed as are suitable for the particular kind of electrode.

The object of the invention is additionally provided by an electrochemical storage cell having a cylindrical cell roll and a housing surrounding the cylindrical cell roll, wherein the cylindrical cell roll comprises an electrode as described above, a counter electrode, and a separator disposed between the electrode and the counter electrode. The collector lugs of the electrode are folded onto a top side formed by the cylindrical cell roll, and are disposed with at least partly no overlap to one another.

The at least partly overlap-free alignment of the collector lugs of the electrode makes it possible to utilize spaces formed between the folded collector lugs, at the top side of the cell roll, to fill the electrochemical storage cell with electrolyte and/or to degas the electrochemical storage cell. This simplifies the process of producing the electrochemical storage cell of the invention, and extends its lifetime.

Through the electrode, having collector lugs only in the first region, the cell roll can have a denser winding and, moreover, at least partly overlap-free arrangement of the collector lugs can be achieved. In this way, the packing density can be increased.

Furthermore, the footprint of the electrode within the housing of the electrochemical storage cell is small, owing to the folding of the collector lugs.

The electrochemical storage cell of the invention combines the advantage of a lower electrical resistance and the associated lower heating during charging and discharging processes, allowing higher charging and discharging rates to be employed, with a long lifetime of the electrochemical storage cell.

The collector lugs may be electrically contacted via an end cap of the electrochemical storage cell. The end cap has, for example, projections and/or recesses which are electrically contacted with the collector lugs.

The folded collector lugs additionally permit simple welding of the housing, to the end cap used for electrical contacting, for example.

The electrochemical storage cell is in particular a round cell, preferably a round cell of type 21700 or larger, for example a round cell of type 21700 or 4680. Larger types of round cells permit higher energy density, but also necessitate reliable temperature management to a greater extent.

In this case, the housing is a cylindrical housing.

To further improve filling with electrolyte and/or degassing processes, the folded collector lugs are disposed in particular with completely no overlap to one another.

The folded collector lugs may be uniformly spaced from one another along an outer edge of the top side of the cell roll. In this way, in particular, a symmetrical distribution of the collector lugs is produced on the top side of the cell roll, allowing temperature differences within the electrochemical storage cell to be minimized particularly well.

The electrode is more preferably an anode and the counter electrode is more preferably a cathode. In this way, the evolution of heat in the anode during charging processes can be limited, allowing the charging rate to be boosted and hence the charging time of the electrochemical storage cell to be lowered. This is an advantage especially for vehicle applications.

In principle, however, the cathode only, or the anode and the cathode, may be an electrode as described above. Where both the anode and the cathode are an electrode as described above, in particular, the collector lugs of one of the electrodes are folded onto the top side of the cell roll, and the collector lugs of the other of the electrodes are folded onto a bottom side of the cell roll, opposite the top side.

The cylindrical cell roll is preferably obtainable by winding of the electrode arrangement along the longitudinal direction of the collector foil, with the electrode arrangement being rolled up starting from the second end of the collector foil toward the first end of the collector foil.

In this embodiment, the second end of the collector foil is on the inside in the cylindrical cell roll—in other words, the second end is the proximal end of the collector foil—whereas the first end of the collector foil in the cylindrical cell roll is on the outside, meaning that the first end is the distal end of the collector foil, and is therefore closer to the cylindrical housing.

Owing to the arrangement of the collector lugs in the first region of the electrode, production of the cell roll in this way ensures that in the completed cell roll, the collector lugs are distributed over a greater radius than would be the case if the first end were on the inside in the cell roll. In this way, it is possible to further minimize the extent of the overlap between the collector lugs in the installed position of the electrode or to completely avoid such overlap.

In particular, the extent of the first region of the electrode along the longitudinal direction of the collector foil corresponds at most to the circumference of the outer edge of the cylindrical cell roll. This makes it possible to ensure that the collector lugs are positioned as far to the outside as possible in the cell roll.

The electrochemical storage cell is preferably a lithium-ion cell.

Further features and properties of the invention are apparent from the description hereinafter of a preferred embodiment, which is not to be understood in a limiting sense, and also from the drawings.

### BRIEF DESCRIPTION OF THE DRAWINGS

FIG. 1 shows an electrode according to an exemplary embodiment,

FIG. 2 shows a partially rolled-up cylindrical cell roll with an electrode according to the exemplary embodiment of FIG. 1, and

FIG. 3 is a cross-sectional view of a storage cell with the electrode of FIG. 1.

### DETAILED DESCRIPTION OF THE DRAWINGS

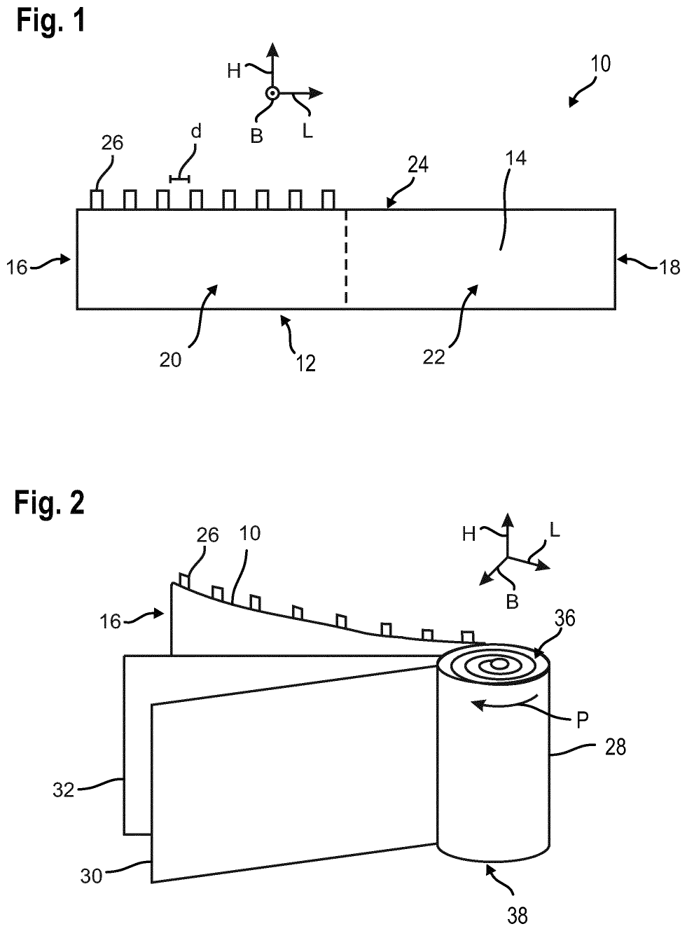

Represented in FIG. 1 is an electrode 10 according to one exemplary embodiment of the invention.

The electrode 10 comprises a collector foil 12, which bears an applied electrode coating 14.

In the embodiment shown, the collector foil 12 is a copper foil.

The collector foil 12 extends from a first end 16 to a second end 18, opposite in a longitudinal direction L, of the collector foil 12, with the collector foil 12 having a first portion 20 and a second portion 22 bordering the first portion 20 in the longitudinal direction. FIG. 1 indicates the transition from the first portion 22 to the second portion 22 with a dashed line.

The collector foil 12 also has a side edge 24, which extends along the longitudinal direction L of the collector foil 12, from the first end 16 to the second end 18 of the collector foil, over the first portion 20 and the second portion 22.

Starting from the side edge 24, there extend multiple collector lugs 26 of the collector foil 12, which serve for electrically contacting the electrode 10.

In the embodiment shown, the collector lugs 26 are an integral constituent of the collector foil 12.

In this case, “starting from the side edge” means that the collector lugs 26 extend in the height direction H shown in FIG. 1 and from an imaginary straight line which is parallel to the longitudinal direction L and whose position is defined by the position of the side edge 24 in height direction H in the second region 22.

In the view represented in FIG. 1, the collector foil 12 is provided substantially completely with the electrode coating 14. In other words, the collector foil 12 is not directly visible, apart from the collector lugs 26, since the electrode coating 14 substantially covers the collector foil 12.

In principle, however, the electrode coating could also be applied differently. For example, a peripheral region close to the side edge 24 could be free of the electrode coating 14.

In the embodiment shown, the electrode 10 has a total of eight collector lugs 26. In principle, however, it is also possible to employ fewer or more collector lugs 26, provided at least two collector lugs 26 are provided.

As can be seen in FIG. 1, the collector lugs 26 are disposed solely in the first portion 20 of the collector foil 12.

In the embodiment shown, the first portion 20 extends from the first end 16 of the collector foil 12 to about the middle of the side edge 24, in other words to half of the overall length of the collector foil 12 in longitudinal direction L, as indicated by the dashed line in FIG. 1.

In principle, however, the first portion 20 may also be shorter, extending, for example, over only a quarter or a third of the overall length of the collector foil 12 in longitudinal direction L.

The collector lugs 26 have the same geometrical configuration and also a uniform distance d from one another.

It will be appreciated that the collector lugs 26 may, however, also have different geometries and/or be spaced at different distances from one another.

Represented schematically in FIG. 2 is a partially rolled-up cylindrical cell roll 28.

The cylindrical cell roll 28 comprises an electrode arrangement with the above-described electrode 10, a counter electrode 30, and a separator 32, which is disposed between the electrode 10 and the counter electrode 30 and electrically insulates the electrode 10 and the counter electrode 30 from one another.

In the embodiment represented, the electrode 10 is an anode and the counter electrode 30 is a cathode.

It is apparent in FIG. 2 that the electrode arrangement is wound to give the cylindrical cell roll 28, with the electrode arrangement being rolled along the longitudinal direction L of the collector foil 12, starting from the second end 18 (see FIG. 1) toward the first end 16, as indicated by the arrow P in FIG. 2.

This may be performed using, for example, a winding mandrel (not shown).

The cell roll has a topside 36 and also a bottom side 38, which is opposite along a height direction H.

The electrode arrangement is wound up such that the collector lugs 26 protrude in height direction H from the top side 36 of the cell roll 28. In this way, the collector lugs 26 can be folded into the plane B-L onto the top side 36. In other words, in an installed position, the collector lugs 26 lie substantially flatly on the top side 36 of the cell roll 28.

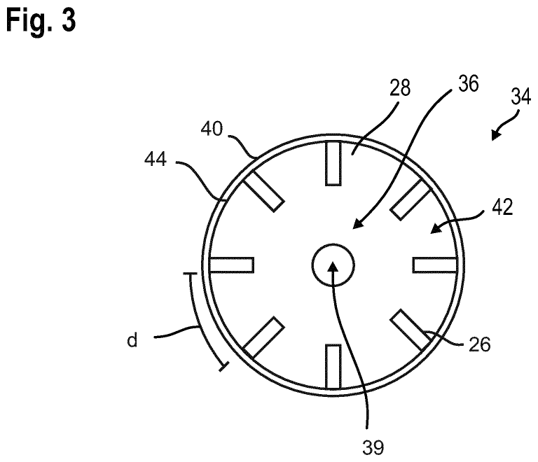

FIG. 3 shows an electrochemical storage cell 34 of the invention in cross section, the cross section running perpendicularly to the height direction H of the cell roll 28, shown in FIG. 2, above the top side 36 of the cell roll 28.

The electrochemical storage cell 34 possesses a housing 40, which accommodates the cylindrical cell roll 28 and surrounds it in the installed position.

In the embodiment shown, the housing 40 is a cylindrical housing, provided that the electrochemical storage cell 34 is a round cell.

In FIG. 3, the spiral course of the wound electrode arrangement within the cell roll 28 is not shown in more detail, in order to simplify the representation.

Centrally within the cell roll 28, there is a cavity 39, which extends axially over the height of the cell roll 28 and which was produced by the process of winding the cell roll 28.

The collector lugs 26 are folded onto the top side 36 of the cell roll 28 and are completely free from overlap.

In other words, the collector lugs 26 are not in mutual contact in the installed position of the cell roll 28. It is possible accordingly for the spaces 42 formed between the folded collector lugs 26 to be utilized for filling the housing 40 with electrolyte and/or for degassing the electrochemical storage cell 34. In this way, the production of the electrochemical storage cell 34 can be simplified and/or accelerated, and the lifetime of the electrochemical storage cell 34 extended.

In the embodiment shown, the collector lugs 26 are distributed symmetrically along an outer edge 44 of the top side 36 of the cell roll 28.

Because of the presence of collector lugs 26 only in the first portion 20 of the collector foil 12, the electrode 10 can be rolled up such that the collector lugs 26 extend only from the outer edge 44 and not starting from a point on the cell roll 28 that is radially further inward. In this way, for a given geometry of the collector lugs 26, a reduced overlap between the collector lugs 26 is possible, or such overlap may be avoided completely, as in the embodiment shown.

The distance of the collector lugs 26 from one another in the installed position of the cell roll 28 is determined by the distance d between the collector lugs 26. As is apparent in FIG. 3, the distance d is greater than the respective length of the collector lugs 26 in the radial direction to the cavity 39.

The collector lugs 26 are contacted via an end cap (not shown) welded to the housing 40. Because the collector lugs 26 are folded, robust welding can easily be carried out without risking damage to the collector lugs 26.

1.-10. (canceled)

11. An electrode for an electrochemical storage cell, comprising:
a collector foil; and
an electrode coating applied to the collector foil,
wherein the collector foil has a first portion and a second portion, which borders the first portion in the longitudinal direction of the collector foil, and has a side edge which extends from a first end to a second end, opposite along the longitudinal direction, of the collector foil over the first portion and second portion,
wherein the collector foil has a plurality of collector lugs, starting from the side edge, for electrically contacting the electrode, and
wherein the collector lugs are disposed in the first portion, and the first portion extends from the first end of the collector foil to at most the middle of the side edge.

12. The electrode according to claim 11, wherein
the collector lugs are an integral constituent of the collector foil.

13. The electrode according to claim 11, wherein
ten or fewer collector lugs are present.

14. The electrode according to claim 13, wherein
six to eight collector lugs are present.

15. The electrode according to claim 11, wherein
the collector lugs are disposed at a uniform distance from one another.

16. An electrochemical storage cell, comprising:
a cylindrical cell roll; and
a housing surrounding the cylindrical cell roll,
wherein the cylindrical cell roll comprises an electrode; a counter electrode; and a separator disposed between the electrode and the counter electrode,
wherein the electrode comprises a collector foil; and an electrode coating applied to the collector foil,
wherein the collector foil has a first portion and a second portion, which borders the first portion in the longitudinal direction of the collector foil, and has a side edge which extends from a first end to a second end, opposite along the longitudinal direction of the collector foil over the first portion and second portion,
wherein the collector foil has a plurality of collector lugs, starting from the side edge, for electrically contacting the electrode, and wherein the collector lugs are disposed in the first portion, and the first portion extends from the first end of the collector foil to at most the middle of the side edge,
wherein the collector lugs of the electrode are folded onto a topside formed by the cylindrical cell roll and are disposed with at least partly no overlap to one another.

17. The electrochemical storage cell according to claim 16, wherein
the folded collector lugs are disposed with completely no overlap to one another.

18. The electrochemical storage cell according to claim 16, wherein
the folded collector lugs are spaced uniformly from one another along an outer edge of the top side.

19. The electrochemical storage cell according to claim 16, wherein
the electrode is an anode and the counter electrode is a cathode.

20. The electrochemical storage cell according to claim 16, wherein
the cylindrical cell roll has a wound electrode arrangement comprising the electrode, the counter electrode, and the separator, the electrode arrangement being rolled up along the longitudinal direction of the collector foil starting from the second end toward the first end.

21. The electrochemical storage cell according to claim 16, wherein
the electrochemical storage cell is a lithium-ion cell.
